(19) United States
(12) Patent Application Publication
(10) Pub. No.: US 2013/0111327 A1
(43) Pub. Date: May 2, 2013

(54) ELECTRONIC APPARATUS AND DISPLAY CONTROL METHOD

(71) Applicants: Hideki Tsutsui, Tachikawa-shi (JP); Sachie Yokoyama, Ome-shi (JP); Toshihiro Fujibayashi, Hino-shi (JP)

(72) Inventors: Hideki Tsutsui, Tachikawa-shi (JP); Sachie Yokoyama, Ome-shi (JP); Toshihiro Fujibayashi, Hino-shi (JP)

(73) Assignee: KABUSHIKI KAISHA TOSHIBA, Tokyo (JP)

(21) Appl. No.: 13/572,233

(22) Filed: Aug. 10, 2012

(30) Foreign Application Priority Data
Oct. 31, 2011 (JP) 2011-239106

(51) Int. Cl. G06F 17/20

(52) U.S. Cl. 715/234

(57) ABSTRACT

According to one embodiment, an electronic apparatus displays a page on a screen based on a source written in a markup language. The apparatus searches for a second element in the source based on an analysis result on the source. The second element has an order relationship with a first element. The first element is a part of descriptions in the source. The part of the descriptions corresponds to a first context selected in the page. The apparatus changes a display state of the page in response to an instruction for designating the order relationship, so as to display, on the screen, a second context on the page. The second context corresponds to the second element.

### CROSS-REFERENCE TO RELATED APPLICATIONS

This application is based upon and claims the benefit of priority from prior Japanese Patent Application No. 2011-239106, filed Oct. 31, 2011, the entire contents of which are incorporated herein by reference.

### FIELD

Embodiments described herein relate generally to an electronic apparatus which can display pages based on sources written in a markup language and a display control method applied to the electronic apparatus.

### BACKGROUND

Recently, various kinds of electronic apparatuses such as personal computers (PCs), tablet PCs, and smartphones have been developed. Many electronic apparatuses of these kinds use browsers to display various kinds of pages (web pages). In general, a page displayed by a browser is constituted by a plurality of blocks (a plurality of contexts) visually recognizable to a user. The user can display a desired context in a page on a browser screen by operating the browser using a scroll bar and the like on the browser screen.

The user of an electronic apparatus including a touch panel can enlarge and display, on a screen, a context in a page displayed on the screen by designating the context by double touch operation (zoom operation) or the like.

However, the user cannot designate a context outside a screen by double touch operation or the like. Especially when the user zooms a given context in a page, several other contexts in the page fall outside the screen. That is, these contexts are not likely to be displayed.

In order to enlarge and display a desired context which is not displayed, the user scrolls the page so as to display the desired context on the screen by using a scroll bar or the like, and then designates the desired context by double touch operation or the like. Alternatively, it is necessary to reduce and display a page so as to display the overall page first and then designate the desired context by double touch operation or the like.

As described above, in order to display the desired context on the browser screen so as to allow the user to easily browse the desired context, many operations are required. For this reason, it is required to display the desired context with simple operation.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of an electronic apparatus according to the first embodiment;

FIG. 2 is an exemplary view showing an example of a display screen of a browser executed by the electronic apparatus according to the first embodiment;

FIG. 3 is an exemplary view for explaining a page displayed on the screen of the electronic apparatus according to the first embodiment and the source of the page;

FIG. 4 is an exemplary view showing an example of a change in display contents displayed on the screen of the electronic apparatus according to the first embodiment;

FIG. 5 is an exemplary block diagram showing the system arrangement of the electronic apparatus according to the first embodiment;

FIG. 6 is an exemplary block diagram showing an example of the configuration of a display control program executed by the electronic apparatus according to the first embodiment;

FIG. 7 is an exemplary block diagram showing another example of the configuration of the display control program executed by the electronic apparatus according to the first embodiment;

FIG. 8 is an exemplary flowchart showing an example of a procedure for changing processing of a context displayed on the screen, which is executed by the electronic apparatus according to the first embodiment;

FIG. 9 is an exemplary flowchart showing another example of the procedure for changing processing of the context displayed on the screen, which is executed by the electronic apparatus according to the first embodiment;

FIG. 10 is an exemplary flowchart showing an example of a procedure for analysis processing of an element on the source, which is executed by the electronic apparatus according to the first embodiment;

FIG. 11 is an exemplary view for explaining control on the magnification ratio of the context by the display control program executed by the electronic apparatus according to the first embodiment;

FIG. 12 is an exemplary view showing an example of a change in the display contents displayed on the screen of an electronic apparatus according to the second embodiment;

FIG. 13 is an exemplary view showing an example of the display screen of a browser executed by an electronic apparatus according to the third embodiment; and

FIG. 14 is an exemplary view showing an example of the source used by the display control program executed by the electronic apparatus according to the third embodiment.

### DETAILED DESCRIPTION

Various embodiments will be described hereinafter with reference to the accompanying drawings.

In general, according to one embodiment, an electronic apparatus displays a page on a screen based on a source written in a markup language. The electronic apparatus includes an analysis processing module and a display control module. The analysis processing module searches for a second element in the source based on an analysis result on the source, wherein the second element has an order relationship with a first element. The first element is a part of descriptions in the source. The part of the descriptions corresponds to a first context currently selected in the page. The display control module changes a display state of the page in response to an instruction for designating the order relationship, so as to display, on the screen, a second context on the page. The second context corresponds to the second element in response to an instruction to designate the predetermined order relation.

### First Embodiment

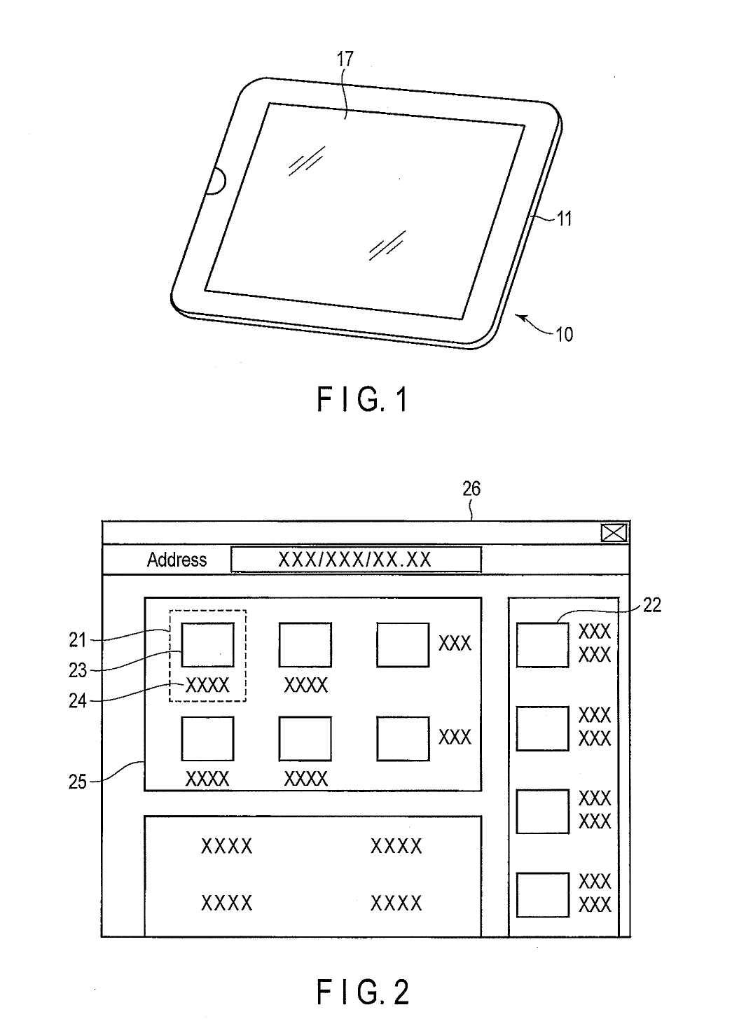

FIG. 1 is a perspective view showing the outer appearance of an electronic apparatus according to an embodiment. This electronic apparatus can be implemented as, for example, a slate personal computer (PC), laptop PC, smartphone, or PDA. Note that this electronic apparatus may be a device incorporated in another electronic apparatus. Assume below that this electronic apparatus is implemented as a slate personal computer 10. The slate personal computer 10 includes a computer main body 11 and a touch screen display 17, as shown in FIG. 1.

The computer main body 11 includes a thin, box-like housing. The touch screen display 17 includes a liquid crystal display (LCD) and a touch panel. The touch panel covers the screen of the LCD. The touch screen display 17 is superimposed and mounted on the upper surface of the computer main body 11.

The computer 10 has a web page display function of displaying a web page. A browser displays the web page on the touch screen display 17. The browser is, for example, an application program incorporated in the computer 10. The computer 10 activates the browser in accordance with, for example, an instruction from a user or the like.

The browser acquires web data associated with the web page and displays the web page on the browser screen, based on the web data. The web data is acquired from outside the computer 10 via the Internet. For example, web data is acquired from a server which publishes web pages.

Web data is, for example, the source (source code) for the web page. A source is written in a markup language like the HTML language. The arrangement of the web page displayed on the browser screen is determined based on the written contents of the source. The arrangement of the web page includes the positional relationship of character strings or images which are displayed on the web page, font and color settings for the character string, image size settings, and the like.

The web page on the touch screen display 17 can be displayed while enlarging or reducing part of the web page by moving the user's fingers in contact with the touch panel. By moving the user's finger, for example, the scroll function of the browser can be executed and part of the web page which is not displayed on the browser screen can be displayed on the touch screen display 17.

The computer 10 includes a microphone and hence can detect speech from the user. As described above, the manner of how the web page looks, i.e., the display state of the web page, can be changed by making the computer recognize a specific utterance from the user (a specific word uttered by the user) instead of moving the user's finger on the touch panel to change the manner of how the web page looks.

Note that the computer 10 may include, for example, a keyboard in addition to the touch panel, microphone, and the like. The computer may execute the scroll function of the browser when the user operates the keyboard. The computer 10 may be incorporated in other electronic apparatuses such as a refrigerator. The browser may not be implemented in the computer 10. For example, the computer 10 may remotely control the browser implemented in a server outside the computer 10.

In addition, web data need not be stored in a server outside the computer 10. For example, web data may be stored in an auxiliary storage device or the like inside the computer 10. The computer may display the web page on a browser screen offline by using the stored data.

As described above, web data may be acquired from an external server via the Internet. It is possible to use, instead of the Internet, for example, an intranet or another network which can transmit and receive data. In addition, web data may be, for example, an image of the web page generated based on a source instead of a source like that described above. In this case, when the browser displays the image on a browser screen and refers to the source from which the image displayed by the browser is generated, the source may be acquired from an external server like that described above. The above source may be written by using another markup language, other than the HTML language, e.g., the XML language.

FIG. 2 is a view showing a display example of the web page displayed on the screen of the touch screen display 17.

A browser screen 26 is the browser screen displayed on the touch screen display 17 by the browser. The browser screen 26 includes an area to display the web page in addition to an address bar indicating the address of the web page. The web page is constituted by a plurality of contexts.

A context is a block displayed on the web page. In addition, the context may mean a predetermined area on the web page which is indicated for each block and can be visually recognized by the user. That is, a context may be a block on the web page which can be visually recognized by the user. For this reason, it is possible to use the context other than the context like a hyperlink text to move to another page by using the keyboard, mouse, or the like. For example, another context may be included in the area of a predetermined context on the web page.

In the case shown in FIG. 2, the web page displays contexts 21 and 22 and the like. The context 21 is a block to display an image such as a still image and a character string. The context 22 is a block to display an image such as a still image. Contexts 23 and 24 are included in the area of the context 21 on the web page. The context 23 displays an image such a still image. The context 24 displays a character string. A context 25 includes the context 21 and other contexts similar to the context 21.

Although the web page constituted by a plurality of contexts has been described with reference to FIG. 2, the web page may include one context. In addition, an address bar need not always be displayed on the browser screen 26.

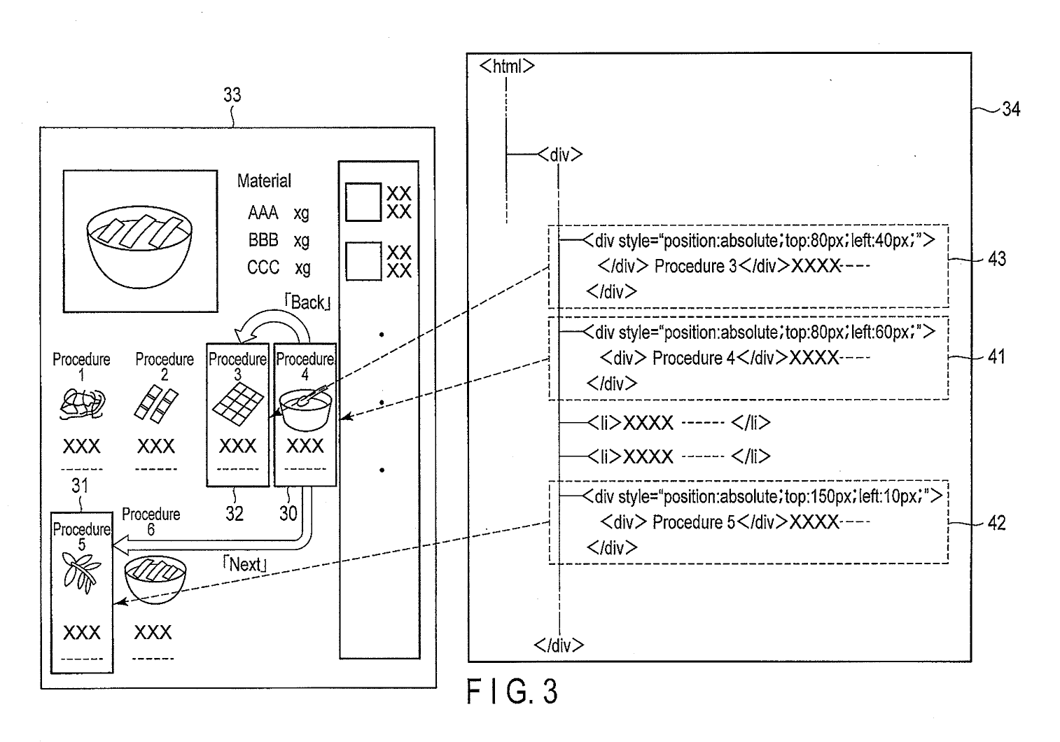

FIG. 3 is a view showing an example of the correspondence relationship between a web page context and the source of the web page.

As described above, the web page is displayed based on the source (i.e., HTML source code) written in the HTML language. That is, each context displayed on the web page corresponds to an element which is part of the source corresponding to the web page.

This embodiment assumes that several contexts of the contexts constituting a web page have an order relation. An order relation indicates a relation characteristic between contexts, which indicates the order of contexts to be noted by the user.

This relation will be concretely described with reference to FIG. 3. The web page constituted by contexts having the order relation will be described with reference to FIG. 3.

A web page 33 and a source 34 corresponding to the web page 33 are respectively shown on the left and right sides in FIG. 3. FIG. 3 shows the contents of a cooking recipe. A plurality of contexts such as contexts 30, 31, and 32 having the order relation indicating a cook procedure is displayed on the web page 33.

The context 31 is a context including contents following the contents of the context 30. The context 32 is a context including contents preceding the contents of the context 30. Each of the contexts 30, 31, and 32 includes an image and a character string. Note that these images and character strings each may be a context.

The source 34 is constituted by a plurality of elements respectively corresponding to a plurality of contexts on the web page 33. The source 34 is written in the HTML language as described above. The source 34 has a hierarchical document structure using tags. An element indicates part of the description on the source 34. An element also represents one HTML tag on the source 34. As shown in FIG. 3, An element may include a document of the source 34 which is sandwiched between predetermined tags. Referring to FIG. 3, elements are indicated by elements 41, 42, and 43.

The elements 41, 42, and 43 respectively correspond to the contexts 30, 31, and 32. The element 41 will be concretely described. The browser determines the display position of the context 30 corresponding to the element 41 on the browser screen 26 based on the source 34. It is therefore possible to acquire the display coordinates of the context 30 corresponding to the element 41 on the browser screen 26 from the browser. Note that the description contents of the source 34 indicated by the element 41 (to be also referred to as the contents of the element 41 hereinafter) may include information indicating the coordinate position of the context 30 on the web page 33. The display location of the context 30 on the web page 33 may be determined based on the information of this coordinate position. In addition, the contents of the element 41 include information indicating contents included in an area on the web page 33 which is indicated by the context 30 (to be also referred to as the contents of the context 30 hereinafter). For example, the character string “procedure 4” in the contents of the context 30 is displayed in accordance with the description “<div> procedure 4 </div>” included in the contents of the element 41. Likewise, the contents of the context 31 in an area on the web page 33 which is indicated by the context 31 is displayed in accordance with the contents of the element 42. The contents of the context 32 in an area on the web page 33 which is indicated by the context 32 is displayed in accordance with the contents of the element 43. In this manner, the contents of contexts on the web page 33 based on the contents of elements is displayed.

Assume that the context 30 is currently selected. The currently selected context 30 is called a current context. The current context may be, for example, a context enlarged/displayed (zoomed) on the touch screen display 17 or a context displayed (centered) in a central portion of the screen of the touch screen display 17. When the user utters a word having the order relation such as “next” while the context 30 is the current context, the computer analyzes the contents of the context 30 and searches the page for a context corresponding to “next”. In this case, the computer finds the context 31 including the character string “procedure 5” following the character string “procedure 4” in the context 30 as a context corresponding to “next”.

If a context corresponding to “next” is found, the found context becomes a new current context. The computer then changes the display state of the web page 33 so as to display the found context on the screen of the touch screen display 17. In this case, for example, by scrolling the web page 33, the context 31 may be displayed in the central portion of the screen of the touch screen display 17. Alternatively, by scrolling the web page 33, the context 31 to the central portion of the screen of the touch screen display 17 may be moved and enlarged.

If the user utters a word having the order relation like “back” while the context 30 is a current context, the computer analyzes the contents of the context 30 and searches the page for a context corresponding to “back”. In this case, the computer finds the context 32 including the character string “procedure 3” preceding the character string “procedure 4” in the context 30 as a context corresponding to “back”.

If the computer has found a context corresponding to “back”, the found context becomes a new current context. The computer then changes the display state of the web page 33 so as to display the found context on the screen of the touch screen display 17. For example, by scrolling the web page 33, the context 32 may be displayed in the central portion of the screen of the touch screen display 17. Alternatively, by scrolling the web page 33, the context 32 may be moved and enlarged to the central portion of the screen of the touch screen display 17.

Assume further that while a new current context is displayed, a word like “next” or “back” has been input. In this case, the computer automatically find a context corresponding to “next” or “back” with respect to the new current context. This found context becomes a new current context.

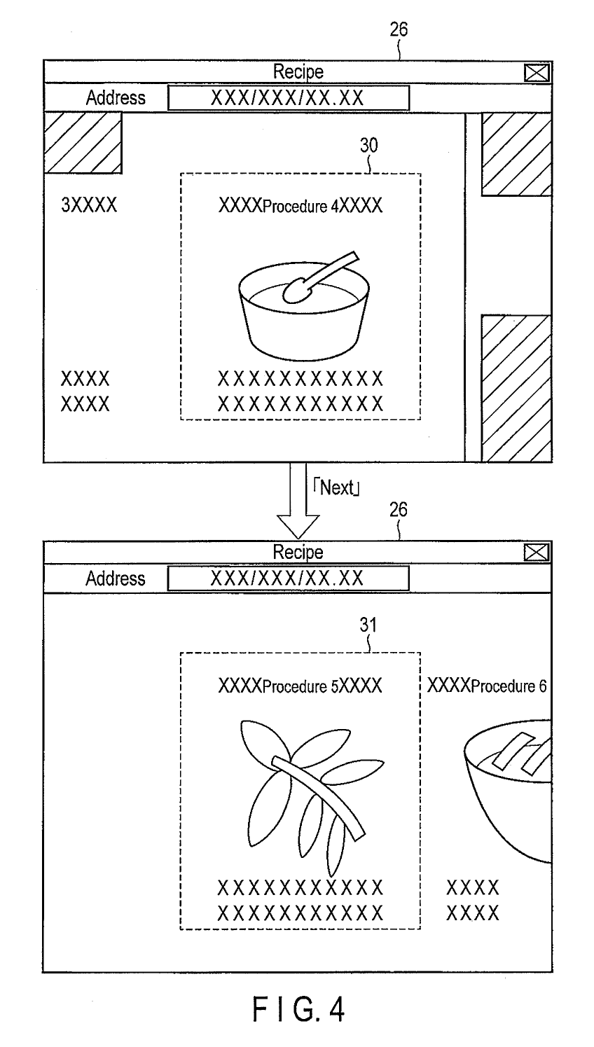

The transition of the display contents of the web page 33 displayed on the browser screen 26 in this embodiment will be described next with reference to FIG. 4.

This embodiment assumes that the computer displays part of the web page 33 which is formed from a context having an order relation on the browser screen 26 while enlarging the part by using the browser. Assume that at this time, the user wants to enlarge and display, on the browser screen 26, a context following or preceding the context enlarged and displayed on the browser screen 26. In this case, the following or preceding context is enlarged and displayed on the browser screen 26 in accordance with an instruction from the user.

This operation will be concretely described with reference to FIG. 4. The case shown in FIG. 4 assumes that the user is browsing the web page 33 shown in FIG. 3 by using the browser. Referring to FIG. 4, the context 30 is enlarged and displayed in the central portion of the browser screen 26. Almost all the contexts other than the context 30 fall outside the browser screen 26 and are not displayed. In this state, when the user inputs a word indicating an order relation such as “next”, the context 31 as the next context is enlarged and displayed in the central portion of the browser screen 26. In this manner, in this embodiment, when the user issues a request to change the context (the current context) currently enlarged (zoomed) and displayed on the browser screen 26, a context corresponding to the request is displayed on the browser screen 26 in response to the request as a trigger. Note that an element on the source 34 which corresponds to the current context will be referred to as a current element hereinafter. If, for example, the current context is the context 30 in FIG. 3, the current element corresponds to the element 41.

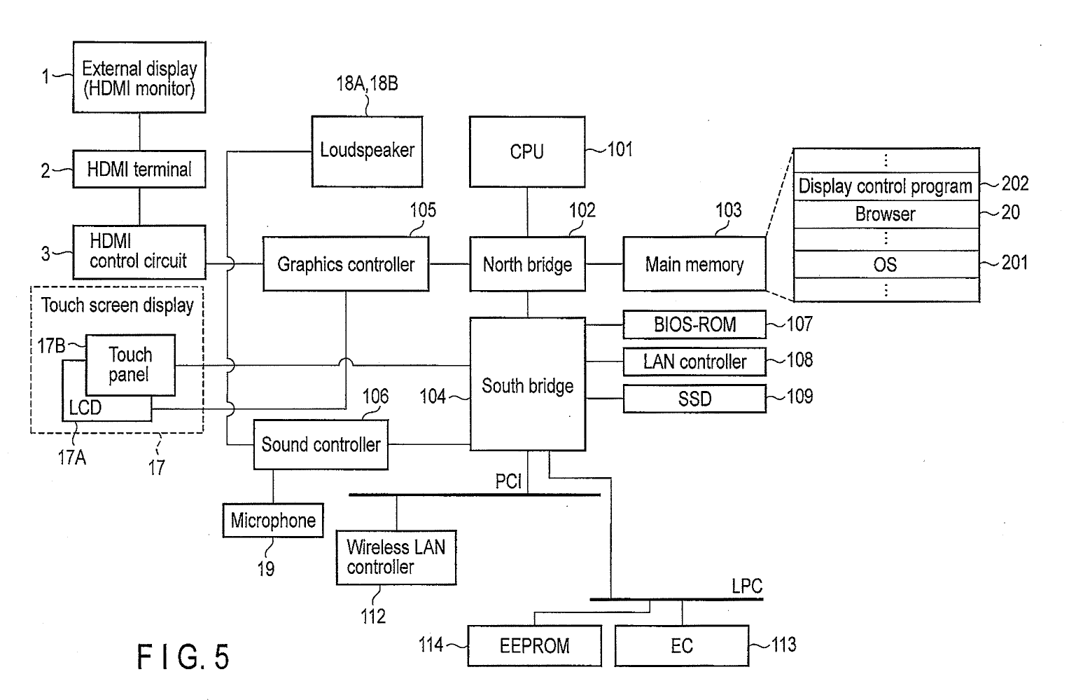

FIG. 5 shows the system arrangement of the computer 10.

As shown in FIG. 5, the computer 10 includes a CPU 101, a north bridge 102, a main memory 103, a south bridge 104, a graphics controller 105, a sound controller 106, a BIOS-ROM 107, a LAN controller 108, a solid-state drive (SSD) 109, a wireless LAN controller 112, an embedded controller (EC) 113, an EEPROM 114, an LCD 17A, a touch panel 17B, and the like.

The CPU 101 is a processor which controls the operation of each component in the computer 10. The CPU 101 executes an operating system (OS) 201 and various kinds of application programs which are loaded from the SSD 109 into the main memory 103. The application programs include a browser 20 and a display control program 202. The browser 20 is software for displaying the above web pages, and is executed on the operating system (OS) 201. The display control program 202 is executed as a plug-in of the browser 20, that is, a browser plug-in. Note that the display control program 202 may be a program other than a browser plug-in, for example, a program independent of the browser 20. Alternatively, the display control program 202 may itself incorporate the function of the browser 20.

The CPU 101 also executes the BIOS stored in the BIOS-ROM 107. The BIOS is a program for hardware control.

The north bridge 102 is a bridge device connected between the local bus of the CPU 101 and the south bridge 104. The north bridge 102 also incorporates a memory controller which performs access control on the main memory 103. The north bridge 102 also has a function of executing communication with the graphics controller 105 via a serial bus based on the PCI EXPRESS specification.

The graphics controller 105 is a display controller which controls the LCD 17A used as a display monitor of the computer 10. The display signal generated by the graphics controller 105 is sent to the LCD 17A. The LCD 17A displays a picture based on the display signal. The touch panel 17B is disposed on the LCD 17A. The touch panel 17B is a pointing device for inputting on the screen of the LCD 17A. The user can operate a graphical user interface (GUI) or the like displayed on the screen of the LCD 17A by using the touch panel 17B. For example, by touching a button displayed on the screen, the user can designate the execution of a function corresponding to the button.

An HDMI terminal 2 is an external display connection terminal. The HDMI terminal 2 can send an uncompressed digital video signal and a digital audio signal to an external display device 1 via one cable. An HDMI control circuit 3 is an interface for sending a digital video signal to the external display device 1 called an HDMI monitor via the HDMI terminal 2. That is, the computer 10 can be connected to the external display device 1 via the HDMI terminal 2 or the like.

The south bridge 104 controls each device on a PCI (Peripheral Component Interconnect) bus and each device on an LPC (Low Pin Count) bus. The south bridge 104 also incorporates an ATA controller for controlling the SSD 109.

The south bridge 104 incorporates a USB controller for controlling various kinds of USB devices. The south bridge 104 has a function of executing communication with the sound controller 106. The sound controller 106 is a sound source device, which outputs audio data to be reproduced to loudspeakers 18A and 18B. The LAN controller 108 is a wired communication device which executes wired communication based on the IEEE802.3 specification. The wireless LAN controller 112 is a wireless communication device which executes wireless communication based on, for example, the IEEE802.11 specification.

The EC 113 is a one-chip microcomputer including an embedded controller for power management. The EC 113 has a function of powering on/off the computer 10 in accordance with the operation of the power button by the user.

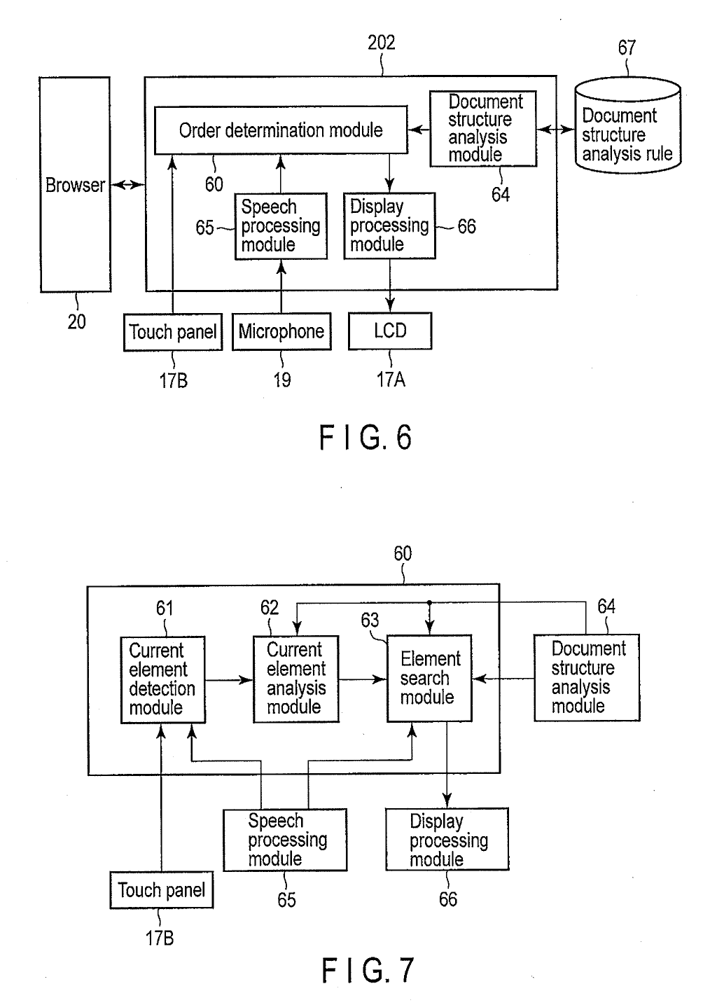

The functional configuration of the display control program 202 will be described next with reference to FIG. 6. The display control program 202 includes an order determination module 60, a document structure analysis module 64, a speech processing module 65, and a display processing module 66.

The order determination module 60 is connected to the touch panel 17B, the speech processing module 65, the display processing module 66, and the document structure analysis module 64. The order determination module 60 functions as an analysis processing module which determines the order relation between a plurality of elements on the source 34 by analyzing the description of the source 34 using the document structure analysis module 64. By determining the order relation between the elements, the order relation between contexts on the web page 33 which respectively correspond to the elements can be decided. That is, the order determination module 60 analyzes the source 34 and searches the source 34 for an element other than the current element in the source 34, which has a predetermined order relation with the current element. The current element is a part of the descriptions in the source 34. The part of the descriptions corresponds to the current context in the web page 33. More specifically, the order determination module 60 analyzes a current element a part of the descriptions of the source 34 which corresponds to the current context in the web page 33, and searches the source for another element in the source 34 which has a predetermined order relation (“next”, “back”, or the like) with the current element, thereby selecting the found another element as a new current element. For example, the order determination module 60 finds the character string including a number from the current element by analyzing the current element. The order determination module 60 finds, from the source, another element including the character string of contents following or preceding the found character string. The order determination module 60 selects the found another element as a new current element. As the character string including a number, for example, a header representing a number can be used. A header representing a number is, for example, the character string including a header word and a number. For example, the above character string “procedure 4” is a header representing a number, which is constituted by the header word “procedure” and the number “4”. Obviously, a header representing a number may be the character string formed from only a number.

Assume that the character string including the header word “procedure” and the number “4” as a key character has been found from the current element. If a word indicating “next” is input, the computer searches the source 34 for another element including the header word “procedure” and the number “5”. If a word indicating “back” is input, the computer searches the source 34 for another element including the header word “procedure” and the number “3”. The order determination module 60 will be described in detail later with reference to FIG. 7.

The document structure analysis module 64 is connected to the order determination module 60 and a document structure analysis rule 67. The document structure analysis module 64 analyzes the document structure of the source 34 under the control of the order determination module 60. The document structure of the source 34 is constituted by tags, character strings (to be also referred to as source character strings hereinafter), and the like written in the source 34. The document structure may indicate the hierarchical structure of tags, the arrangements of source character strings, and the like on the source 34. The document structure analysis module 64 analyzes the document structure based on data for the analysis of document structures (to be also referred to as a document analysis rule hereinafter), which is stored in the document structure analysis rule 67. The document structure analysis rule 67 is stored in an auxiliary storage device such as the SSD 109.

The document analysis rule is an analysis rule for the analysis of the document structure. The analysis rule is a rule for searching for an element similar to (in a sibling relationship with) a current element based on the character string included in the current element. For example, a source character string formed from a combination of a tag type included in the current element and the character string accompanying the number included in the current element is registered in the document structure analysis rule 67 in advance. The document structure analysis module 64 predicts the source character string included in an element in the sibling relationship with the current element from the registered source character string. The document structure analysis module 64 searches the source for the source character string included in the predicted element in the sibling relationship with the current element. More specifically, for example, the source character string “<div> procedure (4.)” is registered in the document structure analysis rule 67 in advance. If the current element includes “<div>procedure (4.1)”, the document structure analysis module 64 predicts the element including <div>procedure (4.2)” as an element in a sibling relationship with the current element. The document structure analysis module 64 searches the source 34 for the source character string “<div> procedure (4.2)”. In addition, a combination of the tag type and the character string may be formed from the character string including a tag, number, and symbol such as “<li> (4)”. Note that the source character string to be registered in advance may not include any tag. Alternatively, an analysis rule may be the one that searches for an element including a source character string similar in arrangement to a character string even with a different tag type as an element in a sibling relationship. Using a plurality of analysis rules in this manner can increase the probability of finding an element in the sibling relationship with the current element. The document structure analysis module 64 analyzes the document structure of the source 34 in accordance with these rules and sends the analysis result to the order determination module 60.

The speech processing module 65 executes speech recognition processing. The speech processing module 65 is connected to the order determination module 60 and a microphone 19. The speech processing module 65 receives a speech input signal from the user via the microphone 19. The speech processing module 65 detects a predetermined word included in the received speech input signal by recognizing the speech input signal. The predetermined word is the one that indicates the order relation, for example, “next”, “back”, “forward”, “backward”, “and”, “then”, “and?”, or the like. The speech processing module 65 sends the recognition result on the speech input signal as an instruction to designate the above order relation to the order determination module 60.

The display processing module 66 is connected to the order determination module 60 and the LCD 17A. The display processing module 66 displays, on the LCD 17A, the data sent from the order determination module 60 based on the data. The data sent from the order determination module 60 is, for example, the information of a context displayed on the browser screen 26. The information of the context is, for example, the coordinate information of the context, information indicating the size of the context, the contents of the context on the web page 33, or the like.

The display processing module 66 operates the browser 20 based on the information of the context. The display processing module 66 changes the display state of the web page 33 so as to display the context to be displayed (new current context) on the browser screen 26. More specifically, the display processing module 66 may display the new current context in the central portion of the browser screen 26 (centering) by scrolling the web page 33. Such as this, the new current context is moved from outside the browser screen 26 to its central portion. Alternatively, the display processing module 66 may move the new current context to the central portion of the browser screen 26 (centering) by scrolling the web page 33 and enlarge (zoom) the new current context. In this case, the display processing module 66 calculates a magnification ratio to be applied to the new current context, that is, the magnification ratio to be applied to the web page 33, based on the size of the new current context, so as to enlarge the new current context to match its size with size of the browser screen 26. The display processing module 66 may displays the new current context on the browser screen 26 upon enlarging the new current context in accordance with the magnification ratio. This makes it possible to increase the size of the new current context so as to make the overall new current context fall within the browser screen 26. In this case, the browser screen 26 is identical to the screen of the LCD.

The browser 20 is connected to the display control program 202. The browser 20 is controlled based on control signals from the display control program 202. The browser 20 sends information associated with the web page 33 displayed on the browser screen 26 and the information of displayed contexts to the display control program 202. Information associated with the web page 33 may be, for example, the address of the web page 33 or the source 34.

An example of specific processing by the order determination module 60 will be described next with reference to FIG. 7.

The order determination module 60 includes a current element detection module 61, a current element analysis module 62, and an element search module 63.

The current element detection module 61 is connected to the touch panel 17B, the speech processing module 65, and the current element analysis module 62. The current element detection module 61 performs detection or setting of the current element (to be also referred to as current element detection hereinafter). To perform current element detection is to decide the current element as a criterion for the determination of the order relation. Performing current element detection can find, from the source 34, an element including contents corresponding to “next” with respect to the current element or an element including contents corresponding to “back” of the current element. The current element detection module 61 detects, as the current element, an element corresponding to the current context indicating the currently selected context in the web page 33. The current context may be the currently selected context or the context enlarged and displayed on the browser screen 26. The current context may be the character string displayed on the web page 33 (to be also referred to as a page character string hereinafter) or the context designated when the user utters information that can specify a context displayed on the web page 33 in speech such as “procedure 4” based on the data sent from the speech processing module 65. Alternatively, the current context may be a context on the web page 33 which is designated by a double tap gesture by the user.

The current element analysis module 62 is connected to the current element detection module 61, the element search module 63, and the document structure analysis module 64. The current element analysis module 62 analyzes the contents of the current element (the description of the current element) detected by the current element detection module 61. The contents of the current element include the document structure of the current element or the character string included in the current element. The current element analysis module 62 analyzes the contents having the order relation which are included in the current element based on the document structure of the source 34 analyzed by the document structure analysis module 64. The contents having the order relation may be the character string including a number included in the tag of the current element. The current element analysis module 62 sends the analysis result on the current element to the element search module 63.

The element search module 63 is connected to the current element analysis module 62, the document structure analysis module 64, the speech processing module 65, and the display processing module 66. The element search module 63 searches the source 34 for another element having the order relation with the current element (to be referred to as an order relation element hereinafter) based on the analysis result on the current element obtained by the current element analysis module 62 and the analysis result on the source 34 obtained by the document structure analysis module 64. The element search module 63 instructs the display processing module 66 to display the context corresponding to the order relation element on the browser screen 26.

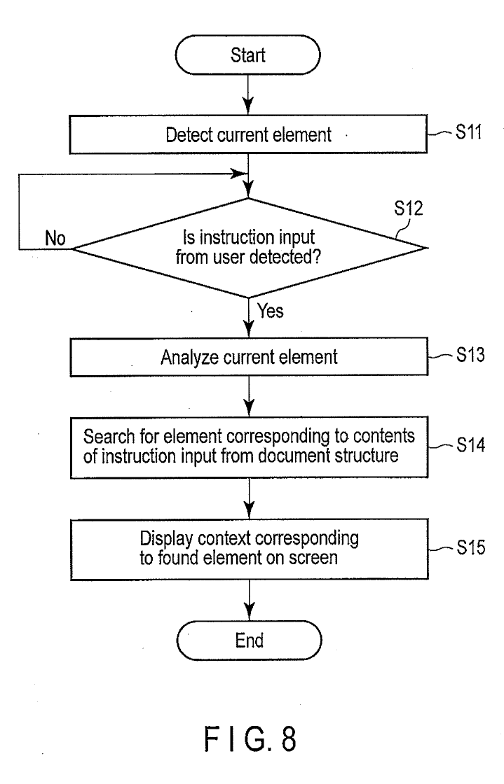

An example of display switching processing for contexts to be displayed on the browser screen 26 will be described next with reference to the flowchart of FIG. 8. FIG. 8 assumes that after the user issues an instruction to switch contexts, a context “next” or “back” with respect to the current context is searched.

The current element detection module 61 detects a current context (step S11). In step S11, the current element detection module 61 detects, as a current context, a context in the web page 33 which is currently zoomed or centered. Thereafter, the user utters a word having the order relation such as “next”, and the current element detection module 61 detects the word via the microphone 19 (YES in step S12). Note that the user may input an instruction by operation other than speech input operation. For example, the user may input the instruction to change a context to be displayed on the browser screen 26 by using a remote controller which operates the computer 10. The current element analysis module 62 analyzes the current element in accordance with the instruction indicating the order relation from the user (step S13). The current element analysis module 62 analyzes the document structure of the current element based on the document analysis rule and the like using a header indicating a number. Note that this number may be indicated in the form of, for example, “(1)” or “(2)”. The element search module 63 then searches for a context corresponding to the contents of the instruction from the user with respect to the current context based on the document structure analysis result (step S14). The element search module 63 may search for an element including a character string having a predetermined order relation with the character string in the current element. The display processing module 66 displays the context corresponding to the found element on the browser screen 26 (step S15). The display processing module 66 may display the context corresponding to the found element on the browser screen 26 upon centering or zooming or centering and zooming the context. This automatically shifts the display state of the web page 33 from the display state in which the current context is zoomed or centered to the display state in which the new current context corresponding to “next” or “back” with respect to the current context is zoomed or centered.

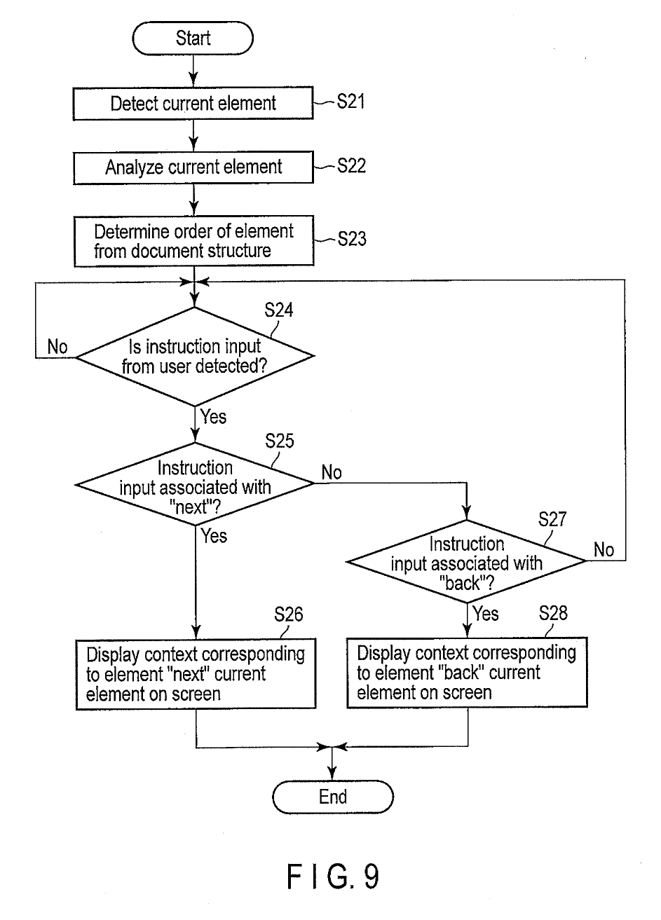

Another example of display switching processing for contexts to be displayed on the browser screen 26 will be described next with reference to the flowchart of FIG. 9. FIG. 9 assumes that before the user issues an instruction to switch a context, a context “next” or “back” with respect to the current context is searched.

When the current element detection module 61 detects a current element (step S21), the computer analyzes the current element before the reception of an instruction having the order relation from the user (step S22). The computer determines the order relation between the current element and another element included in the source 34 based on the analysis result on the current element (step S23). Unlike the case described with reference to FIG. 8, the element search module 63 searches for both elements, namely an element “next” and an element “back” the current element. Upon detecting an instruction input having the order relation from the user thereafter (step S24), the computer determines whether the instruction input from the user is an instruction input associated with “next” (step S25). If the instruction input from the user is an instruction input associated with “next” (YES in step S25), the computer displays a context corresponding to the element “next” on the browser screen 26 (step S26). If the instruction input from the user is not an instruction input associated with “next” (NO in step S25), the computer determines whether the instruction input from the user is an instruction input associated with “back” (step S27). If the instruction input from the user is an instruction input associated with “back” (YES in step S27), the computer displays a context corresponding to the element “back” on the browser screen 26 (step S28). If the instruction input from the user is not an instruction input associated with “back” (NO in step S27), the computer waits for another instruction input from the user.

As has been described with reference to FIG. 9, determining the order of an element in advance by analyzing a current element before an instruction input from the user can shorten the time taken to display a context “next” or “back” with respect to the current context on the browser screen 26 upon reception of an instruction input from the user as compared with the time taken for the processing described with reference to FIG. 8.

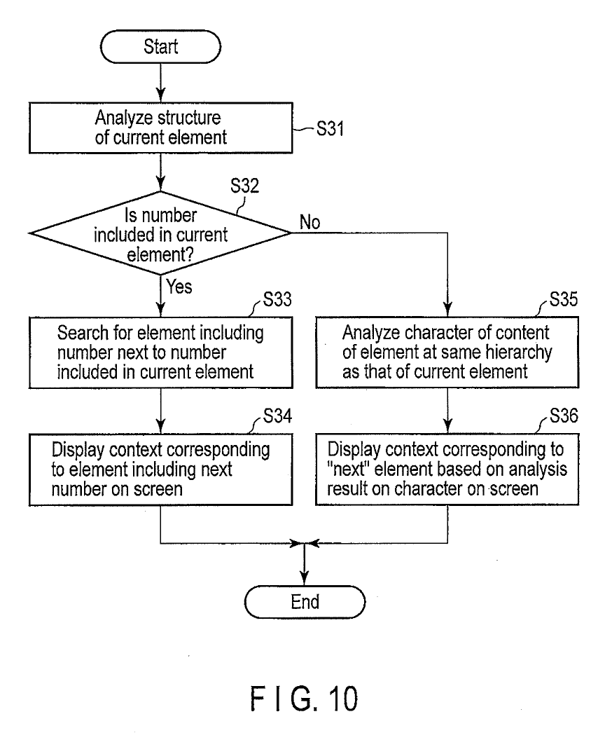

An example of element search processing in this embodiment will be described next with reference to FIG. 10.

The current element analysis module 62 analyzes the structure of a current element (step S31). The element search module 63 determines whether the analyzed current element includes any number (step S32). A case in which the current element includes a number corresponds to a case in which, for example, the tag included in the current element is written like “<div id=1>” or “<div id=2>”. In this case, the computer determines the order relation between elements by using the numbers in the tags. Another case in which the current element includes a number may be a case in which a number is included between tags like “<div> procedure 1 </div>”. If the current element includes a number (YES in step S32), the computer searches for an element including a number next to the number included in the current element (step S33). If, for example, the tag included in the current element is “<div id=1>”, the computer searches for another element on the source 34 which includes “<div id=2>”. If the computer finds an element including the next number as a result of the search, the computer displays a context corresponding to the element including the next number on the browser screen 26 (step S34). If the computer finds no element including the next number as a result of the search, the computer notifies the user of the corresponding information by, for example, speech.

If no tag is included in the tag in the current element (NO in step S32), the computer analyzes the character string of the contents of an element (sibling element) at the same level on the source 34 as that of the current element (step S35). Assume that part of the source 34 is written as follows, and the current element is “<div> procedure 1 . . .

</div>″:
<div>

<div> procedure 1 ... </div>
<div> procedure 2 ... </div>

</div>

In this case, the computer analyzes the leading character string “procedure 2 . . . ” in the second element “<div> procedure 2 . . . </div>” at the same level as that of the current element. The computer uses, for example, a language processing method as an analysis method. The computer uses the language processing method to determine whether, for example, there is continuity between the leading character string in the current element and the leading character string in the second element. For example, the computer determines that there is continuity between “procedure 1 . . . ” and “procedure 2 . . . ”, because the leading character string “procedure” in each element is the same. The display processing module 66 displays, on the browser screen 26, a context on the web page 33 which corresponds to the element “<div> procedure 2 </div>” (step S36). If there is no element at the same level as that of the current element, the computer searches for an element in a sibling relationship with the current element at a level immediately above the level to which the current element belongs, for example, an element including the same type of tag (for example, <div>). Note that the above character string is not limited to a character string constituted by a header word and a number like “procedure 1” or “procedure 2”, and the above character string may be a character string constituted by a symbol and a number like “(1)” or “(2)”.

If the character string included in the current element includes no number, the computer may search for another element corresponding to “next” or “back” with respect to the current element based on a character string including a character which can express the order relation, such as “A”, “B”, or “C”. Such a case corresponds to, for example, a case in which (1) the character string is “procedure A”, “procedure B”, or “procedure C”, (2) the character string is “procedure (a)”, “procedure (b)”, or “procedure (c)”, or (3) the character string is “A”, “B”, or “C”. In this case, if the character string includes at least a character which can express the order relation, it is possible to search for an element by using the method described with reference to FIG. 10.

A case in which a current element includes no character string will be described below. In this case, analyzing the arrangement of the source 34 written in a hierarchical structure, that is, the arrangement of an element (the order of a sibling element), will find an element corresponding to “next” or “back”. More specifically, this is, for example, a case in which a photo list is displayed on the browser screen 26. In this case, the contents of a current context may be only a photo. For this reason, for example, the current element may not include any character string like “procedure 1” described above except for a description such as a tag necessary to display a photo on the browser screen 26. In such a case, the computer finds a sibling element of the current element from the source 34. The computer decides an element “next” or “back” with respect to the current element based on the relationship between the found sibling element and the current element on the source 34. For example, the element corresponding to “next” is a sibling element of the current element, and is an element written after the description of the current element. More specifically, the element corresponding to “next” may be a sibling element written immediately after the current element. The element corresponding to “back” is a sibling element of the current element, and is an element written before the description of the current element. More specifically, the element corresponding to “back” may be a sibling element written immediately before the current element.

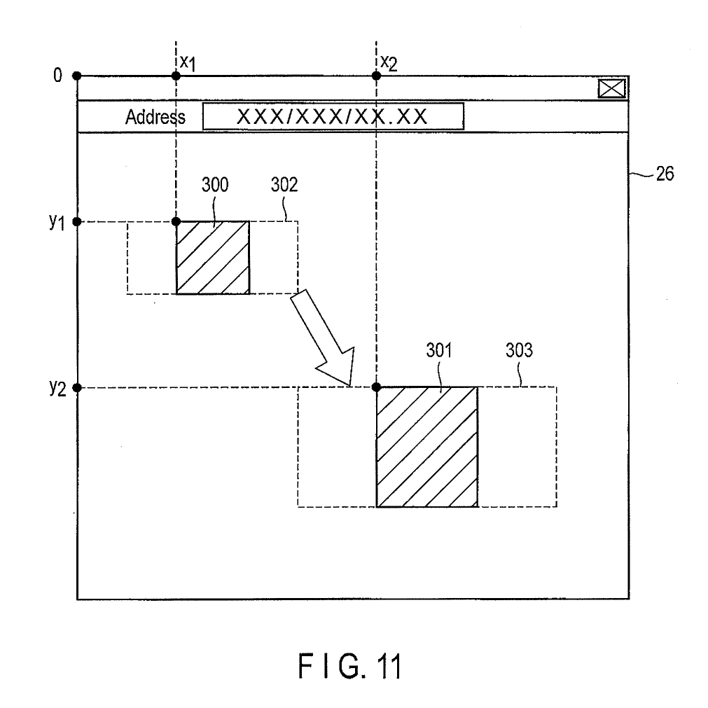

An example of a change in magnification ratio used to enlarge and display a context in this embodiment will be described next with reference to FIG. 11.

Assume that contexts 300 and 301 having different sizes are displayed on the browser screen 26. Assume also that the displayed state of the context 300 enlarged on the browser screen 26 shifts to the displayed state of the context 301 enlarged on the browser screen 26 in accordance with an instruction from the user. Assume also that the entire web page 33 is displayed on the browser screen 26. Window 302 and window 303 indicated by the dotted frames in FIG. 11 represent the browser screen 26 or the touch screen display 17 when the contexts 300 and 301 are enlarged and displayed on the browser screen 26.

The browser 20 displays the context 300 on the browser screen 26 based on an element on the source 34 which corresponds to the context 300. The coordinates of the upper left corner of the area on the web page 33 which is occupied by the context 300 are represented by (x1, y1). Likewise, although not shown, the size of the window 302 is decided based on the coordinates of the right lower corner of the area on the web page 33 which is occupied by the context 300. Based on the size of the window 302, the computer decides the magnification ratio of the context 300 enlarged and displayed. The magnification ratio of the context 301 to be enlarged and displayed is decided by using the same magnification ratio decision method as that for the context 300 described above.

Assume that a plurality of contexts are enlarged and displayed on the browser screen 26 when detecting a current context. In this case, one of a plurality of contexts may be detected as a current context.

As described above, according to this embodiment, when displaying a desired context in a page browsed by the user on a screen, analyzing the elements included in the source of the page allows the user to display the desired context on the screen with simple operation. In addition, analyzing the character string included in each element allows to search for an element on the source which corresponds to the desired context. If the character string included in an element includes a number, it is possible to search for an element on the source which corresponds to a desired context by using the number. If an element includes no character string, analyzing the arrangement of the element on the source allows to search for an element on the source which corresponds to a desired context. In addition, scrolling the page will display the desired context in the central portion of the screen. Furthermore, the desired context is enlarged and displayed on the screen. This makes it possible to display the desired context on the screen in a size that allows the user to easily see and at a position where the user can easily see, without requiring the user to perform any complicated operation. Alternatively, calculating a magnification ratio on a screen so as to match the size of a desired context allows to center and display the desired context on the screen. In addition, it is possible to switch contexts currently displayed in accordance with an instruction from the user. The instruction from the user is an instruction having an order relation. It is possible to search an element on the source which corresponds to a desired context in accordance with the instruction. Moreover, the computer recognizes speech uttered by the user. If the speech includes information indicating the order relation, the computer can display a desired context on the screen in accordance with the contents of the speech.

### Second Embodiment

The second embodiment will be described below with reference to the accompanying drawings. Note that a description of the same arrangements and functions as those of the first embodiment will be omitted.

In the first embodiment, when sequentially displaying the plurality of contexts having the order relation on the browser screen 26, each context is displayed on the browser screen 26 while being enlarged (zoomed) or centered. The second embodiment sequentially displays the plurality of contexts having the order relation by a method other than zooming or centering.

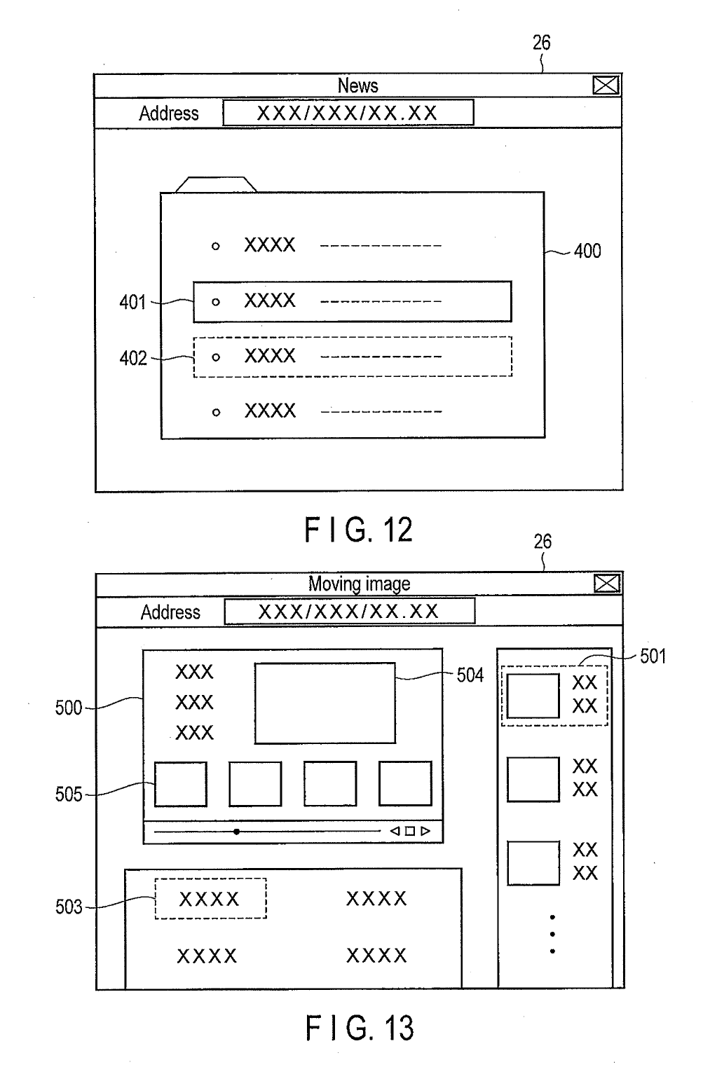

FIG. 12 shows a display example of the context to be noted by the user on a browser screen 26 in accordance with an instruction from the user when the user changes the context to be noted in the second embodiment.

FIG. 12 assumes that the user is browsing the web page associated with news. This web page includes a context 400. The context 400 further includes a context 401 and a context 402. The contexts 401 and 402 each show, for example, the headline of a news article.

In the second embodiment, a display control program 202 highlights the current context in accordance with an instruction by speech input to change the context to be displayed on the browser screen 26.

This operation will be concretely described with reference to FIG. 12. First of all, the display control program 202 detects the current context. For example, when the user utters the character string (page character string) in speech which is displayed on the browser screen 26, the display control program 202 may detect a context including the page character string as a current context. Alternatively, when the user utters a word which allows to specify a context, such as “the news article on the second line”, the display control program 202 may detect a context including the page character string as a current context. Note that the user may issue an instruction to set a current context by using a remote controller or the like as described in the first embodiment instead of speech. FIG. 12 shows a case in which the context 401 is detected as a current context.

The display control program 202 highlights and displays the context 401 on the browser screen 26. More specifically, for example, as shown in FIG. 12, the context 401 as a current context may be highlighted by displaying a frame surrounding the context 401 on the browser screen 26. The frame may be highlighted and displayed by being blinked. Assume also that the highlighted current context is not a context desired by the user. In this case, the display control program 202 may perform processing to make the user check in speech whether a context desired by the user is highlighted, by using speech or the like.

When the user has uttered a word having the order relation, the display control program 202 highlights a context indicating an order relation with a current context. If, for example, the user has uttered the word “next”, the display control program 202 highlights the context 402 as a context “next” with respect to the context 401 as a current context.

Note that an element on the source 34 which corresponds to each of the contexts 401 and 402 may be part of the description on the source 34 which uses the tag “<li>” as indicated as “<li> XXXX . . . </li>” in, for example, FIG. 3.

As described above, according to the second embodiment, when changing the context to be noted by the user, the user can switch between highlighting and not highlighting the context by only using speech. This makes it unnecessary for the user to search the web page 33 for a context to be noted “next” by the user.

### Third Embodiment

The third embodiment will be described below with reference to the accompanying drawings. A description of the same arrangements and functions as those of the first and second embodiments will be omitted.

The third embodiment is configured to display the current context to be noted by the user on a browser screen 26 by a method different from those used in the first and second embodiments. The third embodiment assumes that before a context is changed, the context corresponding to “next” with respect to the current context is not displayed on the browser screen 26. Alternatively, this embodiment assumes that a context corresponding to “next” is displayed in an area on the browser screen 26 which is occupied by the current context. Assume that an element corresponding to a context corresponding to “next” is on the same source as that of an element corresponding to the current context.

This operation will be concretely described with reference to FIG. 13. FIG. 13 shows an example of the browser screen 26 displaying the web page including a moving image (to be also referred to as a moving image page hereinafter). The moving image page is constituted by contexts 500, 501, 503, 504, and 505. The contents of the context 500 include the reproduction of the moving image. That is, the moving image is reproduced in the area on the moving image page which is occupied by the context 500. The contexts 504 and 505 are thumbnail images or the like of moving images as moving image candidates to be produced in the context 500.

Consider that a list of moving images to be reproduced “next” in the context 500 is displayed in the current context 500, as shown in FIG. 13. In this case, when the user utters “next”, the display control program 202 selects a context corresponding to “next” from the contexts 504, 505, and the like, and reproduces a moving image as the contents of the context corresponding to “next” as the contents of the context 500.

Assume further that the moving image is displayed in the current context 500. In this case, when the user utters “next”, the display control program 202 finds an element corresponding to a context which reproduce a moving image corresponding to “next” from the source of the moving image page, and reproduces the moving image corresponding to “next” as the contents of the context 500 in accordance with the contents of the found “next” element.

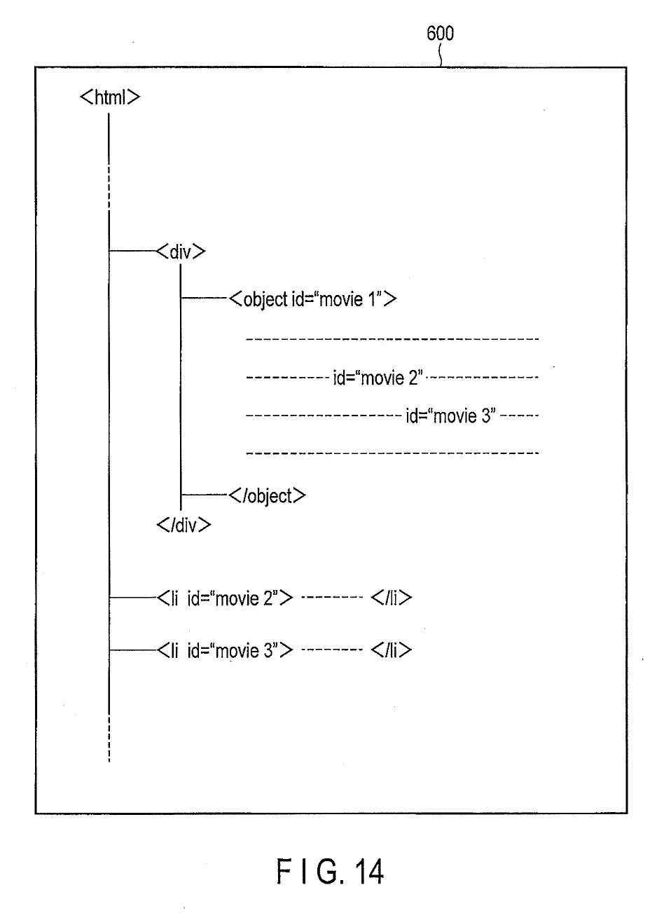

An example of the source of the moving image page will be described next with reference to FIG. 14. The moving image page is displayed on the browser screen 26 based on a source 600 like that shown in FIG. 14. More specifically, for example, when a moving image “movie 2” is reproduced as the contents of the context 500, the display control program detects “<li id=“movie 2”> </li>” as the current context. When the user utters “next”, the display control program 202 searches for “<li id=“movie 3”>. </li>” as an element corresponding to “next” from the source 600. In addition, the display control program 202 finds an element including the character string “movie 2” included in the element of “next” from the source 600. Referring to FIG. 14, the element including the character string “movie 2” is indicated by “<object id=“movie 1”> . . . id=“movie 2” . . . </object>”. The display control program 202 then reproduces the moving image “movie 2” as the contents of a context corresponding to the element including the character string “movie 2”.

As described above, the third embodiment assumes that part of a context having the order relation is not displayed on a page or a context to be displayed “next” is displayed at a position different from that of the current context on the same page. In this case, by only uttering “next”, a “next” context can be displayed on the browser screen 26 by making the computer search for an element having the order relation on a source even if the user cannot visually find the context.

All the procedure described with reference to the flowcharts of FIGS. 8, 9, and 10 can be implemented by programs. It is therefore possible to easily achieve the same effects as those of this embodiment by only installing and executing this program in the computer via a computer-readable storage medium storing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus configured to display a page on a screen based on a source written in a markup language, the electronic apparatus comprising:
an analysis processing module configured to search for a second element in the source based on an analysis result on the source, wherein the second element has an order relationship with a first element, wherein the first element is a part of descriptions in the source, wherein the part of the descriptions corresponds to a first context selected in the page; and
a display control module configured to change a display state of the page in response to an instruction for designating the order relationship, so as to display, on the screen, a second context on the page, wherein the second context corresponds to the second element.

2. The apparatus of claim 1, wherein the analysis processing module is configured to find a character string comprising a number from the first element by analyzing the first element, and wherein the analysis processing module is further configured to search for, as the second element, another element in the source comprising a character string with contents following or preceding the found character string.

3. The apparatus of claim 1, wherein the analysis processing module is configured to find a character capable of expressing the order relationship from the first element by analyzing the first element, and wherein the analysis processing module is further configured to search for, as the second element, another element in the source comprising a character with contents following or preceding the found character.

4. The apparatus of claim 1, wherein the analysis processing module is configured to search for another element at the same level as that of the first element as the second element by analyzing the source.

5. The apparatus of claim 1, wherein the display control module is configured to display the second context in a central portion of the screen by scrolling the page.

6. The apparatus of claim 1, wherein the display control module is configured to move the second context to the central portion of the screen by scrolling the page, and wherein the display control module is further configured to enlarge the second context.

7. The apparatus of claim 6, wherein the display control module is configured to calculate a magnification ratio to be applied to the second context based on a size of the second context so as to enlarge the second context to a size suitable for a size of the screen.

8. The apparatus of claim 1,
wherein the instruction designates the order relationship indicating an order representing either next or back, and
wherein the analysis processing module is configured to search for another element in the source comprising a content following the content of the first element as the second element when the instruction designates the order relationship indicating the order representing the next, and wherein the analysis processing module is configured to search for another element in the source comprising a content preceding the content of the first element as the second element when the instruction designates the order relationship indicating the order representing the back.

9. The apparatus of claim 1, further comprising a speech recognition module configured to execute speech recognition processing and issue the instruction when recognizing speech of a user comprising a word.

10. The apparatus of claim 1,
wherein the analysis processing module is configured to execute analysis of the source and a search for the second element in response to the instruction, and
wherein the display control module is configured to change the display state of the page in response to finding the second element, so as to display, on the screen, the second context on the page corresponding to the second element.

11. The apparatus of claim 1,
wherein the first context is a context enlarged and displayed on the screen, and
wherein the display control module is configured to shift the display state of the page from a first display state in which the first context is enlarged and displayed on the screen to a second display state in which the second context is enlarged and displayed on the screen.

12. A display control method of displaying a page on a screen based on a source written in a markup language, the method comprising:
analyzing the source and searching for a second element in the source based on an analysis result on the source, wherein the second element has an order relationship with a first element, wherein the first element is a part of descriptions in the source, wherein the part of the descriptions corresponds to a first context currently selected in the page; and
changing a display state of the page in response to an instruction to designate the order relationship, so as to display, on the screen, a second context on the page, wherein the second context corresponds to the second element.

13. A computer-readable, non-transitory storage medium having stored thereon a computer program which is executable by a computer, the computer program controlling the computer to execute functions of:
analyzing the source and searching for a second element in the source based on an analysis result on the source, wherein the second element has an order relationship with a first element, wherein the first element is a part of descriptions in the source, wherein the part of the descriptions corresponds to a first context selected in the page; and
changing a display state of the page in response to an instruction to designate the order relationship, so as to display, on the screen, a second context on the page, wherein the second context corresponds to the second element.
